(19) United States
(12) Patent Application Publication
(10) Pub. No.: US 2010/0059416 A1
(43) Pub. Date: Mar. 11, 2010

(54) Material separator

(76) Inventor: Michael David Snow, Bend, OR (US)

Correspondence Address: Thomas M. Spear, Jr., P.O. Box 1274, Bend, OR, 97709-1274, US

(21) Appl. No.: 12/283,318

(22) Filed: Sep. 10, 2008

(51) Int. Cl. B07B 1/46

(52) U.S. Cl. 209/414

(57) ABSTRACT

A material separating apparatus comprising: a frame having a front, left and right wall, said frame having an approximately rectangular shape, a right and left back support column, an upper cross beam attached to the back support columns, a lower cross beam attached and supported by the left and right wall, two or more fixed bars firmly attached to said upper cross beam and said lower cross beam, one or more shift bars, said shift bars are pivotally fixed to said upper cross beam on one end and a lower end rests in a saddle that is fixed upon a lower clip of said lower cross beam, risers attached to the bottom side of said shift bars and a lift bar attached to the lower end of said risers, a means for adjusting the space between two or more fixed or shift bars and means for providing an upward force to said lift beam and thereby pivoting said one or more shift bars.

### CROSS REFERENCE TO RELATED APPLICATION

None

### BACKGROUND OF THE INVENTION

This invention relates generally to material separators. Material separators separate a number of materials including, soil, rocks, gravel, produce, debris, and other material needing separation. In the excavation industry, material separators are referred to as Grizzlies. A material separator is a portable apparatus that is typically used to separate material at the job site. The description in this application focuses on the ability to separate excavated material from a construction site. The description of separating excavated material used in this application is not intended to limit the type of material that can be separated by the material separator described below.

Typically a front loader or similar type earth mover will fill a bucket or similar type loading device with excavated material and transport said excavated material to the material separator. The front loader will then empty the bucket of excavated material over the separator with the material being separated by a series of grate members or screens. Larger material that does not fall through the grate or screen falls away from the smaller material that passes through the grate or screen. The separated material can then be used for specific application depending on the type of material needed for the task.

Generally, material separators are constructed with a rectangular or box like frame that has a slanted grate positioned over an open top. The separator has a front and two sides with the back side being open for removal of separated material. Typically, the separator is placed in a strategic location with respect to the work site. An earth moving device like a front loader will fill a bucket with material from the site then transport the material in the bucket to the separator. The material is dumped or spilled across the bars of the slanted grate. Material that is loose and of smaller dimension than the spacing between the bars of the slanted grate pass through to the box area of the separator. Material that is not loose and is dimensioned larger than the space between the bars of the grate will slide down the sloped grate and fall in front of and outside the box separator.

Further separation of the material can be done by using various sizes or dimensions on the slanted grate. The material that was too large or fell outside the material separator can be processed as needed, including; crushing, disposing, further separating or some other process used in construction industry. This type of separating device has been around for decades, with several innovations or improvements having been patented.

Instead of a slanted grate structure, a screen might be used for separating material with the smaller material falling between the spaces of the screen and the larger pieces falling off the slanted screen. The same principle as the slanted grates except a screen is used instead of the slanted grate bars:

One of the drawbacks noted by several of the patented improvements of the basic design is the need for a means to clean or remove debris that become clogged or stuck on the slanted grate portion of the material separator. Sometimes, material is sized or shaped in such a manner that it is unable to fall between the space of the grates but drops down a small way between two of the slanted grate bar. As the material drops down the size of the material and the shape of the material cause the piece of material to get clogged or jammed between the grate members. When the piece of material is clogged or jammed, it is unable to move down the slanted grate and off the material separator. As the operator of continues to pour more material over the slanted grate, additional material becomes stuck with the clogged or stuck piece of materials and the slanted grate becomes more and more covered with clogged pieces of material and other material that is jammed by the clogged pieces.

When the slanted grate becomes clogged, the ability or efficiency of the material separator decreases and the operator must take steps to clear the clogged or jammed material from the material separator. One solution to clear the debris is accomplished by a worker having to manually remove the clogged pieces by hand or use hand tools such as a sledge hammer to remove the clogged material from the material separators. As long as material were clogged or jammed between the grate members, the efficiency of the device was decreased.

To remedy this type of problem, several designs and innovations have been deployed in the industry. One such innovation to increase the efficiency of the separator includes U.S. Pat. No. 5,544,762, Separating Apparatus, issued to Liimatainen in 1996 which discloses a means for removing clogged or stuck material on the separating grate by hydraulically inverting the separating grate toward a vertical position with the lower attachments of the grate members being free to pivoted upon an upper cross beam of the slanted grate.

Several innovations involve the capability of the operator to adjust the width of the grate members and thereby avoid or minimize the amount of clogging or jamming depending on the type of material being separated. U.S. Pat. No. 6,357,597, Adjustable Grizzly, issued to Theeler in 2002 discloses a means for adjusting the width between the grate members to eliminate or reduce the amount of clogging or jamming of material that gets clogged or stuck between grate members.

Finally, using removable screens have been deployed as well, including U.S. Pat. No. 6,863,182, issued to Zeller, Method and Apparatus for Separating Excavated Material in 2005 disclosed a means for an interchangeable screen assembly which is positioned above the material separator. Interchanging or removable grates or screens provides the user with various openings for the various materials however each size of grate or screen opening requires a separate grate screen. One of the objectives of this invention is to reduce the cost associated with the manufacturing, storing and replacing of removable grates or screens.

Each of the innovations attempts to provide a means or method for the operator to remove clogged or stuck material caught between the grate members due to the size and shape of the particular piece. What is needed is a means for the operator to remove the stuck or clogged material from the material separator in a safe and efficient manner.

### BRIEF SUMMARY OF THE INVENTION

A material separator comprising: a frame having an approximately rectangular shape a left and right back support column attached to the rear of the rectangular frame having an upper and lower end said upper end rising vertically from the back top edge of the right wall, an upper cross beam with a right end and a left end, said ends of the upper cross beam attached to the upper end of said left and right back support column, a lower cross beam with a right end and a left end, said left end of the lower cross beam supported and attached to the top front edge of said left wall, said right end of the lower cross beam supported and attached to the top front edge of said right wall, said upper and lower cross beams being approximately parallel to each other with the upper cross beam being higher with respect to the lower cross beam and toward the back end of said frame, two or more fixed bars, said fixed bars having an upper and lower end, wherein said upper end of the two or more fixed bars are firmly attached to said upper cross beam and said lower end of the two or more fixed bars is firmly attached to said lower cross beam, wherein said two or more fixed bars are attached to said upper and lower cross beams in an approximately parallel arrangement, one or more shift bars, said shift bars having a top and bottom side and an upper and lower end, wherein said upper end of said shift bars is pivotally fixed to said upper cross beam and said lower end rests upon said lower cross beam, wherein a first shift bar is attached to said upper cross beam with each additional lift bar after said first shift bar being arranged approximately parallel to said first shift bar, a riser attached to the bottom side of the one or more shift bars and said riser having an upper and lower end with said upper end attached to said one or more shift bars, a lift bar attached to the lower end of said one or more risers, means for providing an upward force to said lift bar.

### BRIEF DESCRIPTION OF SEVERAL VIEWS OF THE DRAWINGS

FIG. 1 is a right front perspective view of the material separator.

FIG. 2 is an exploded view of the various components of the material separator from a perspective view.

FIG. 3 is back side view of the material separator.

FIG. 4 is a right side view of the material separator with the lift bar in the lowered position.

FIG. 5 is a right side view of the material separator with the lift bar in the raised position.

FIG. 6 is an exploded and blown up view of the shift bar showing the, riser, riser assembly, pivot assembly, the upper and lower clip, saddle, upper and lower fasteners and the lift beam.

### DETAILED DESCRIPTION OF THE INVENTION

The Figures and the description of the material separator and its operation include those components and processes necessary for understanding how the device functions and does not include every possible configuration or operation that could be deployed and would be readily understood by those skilled in the art.

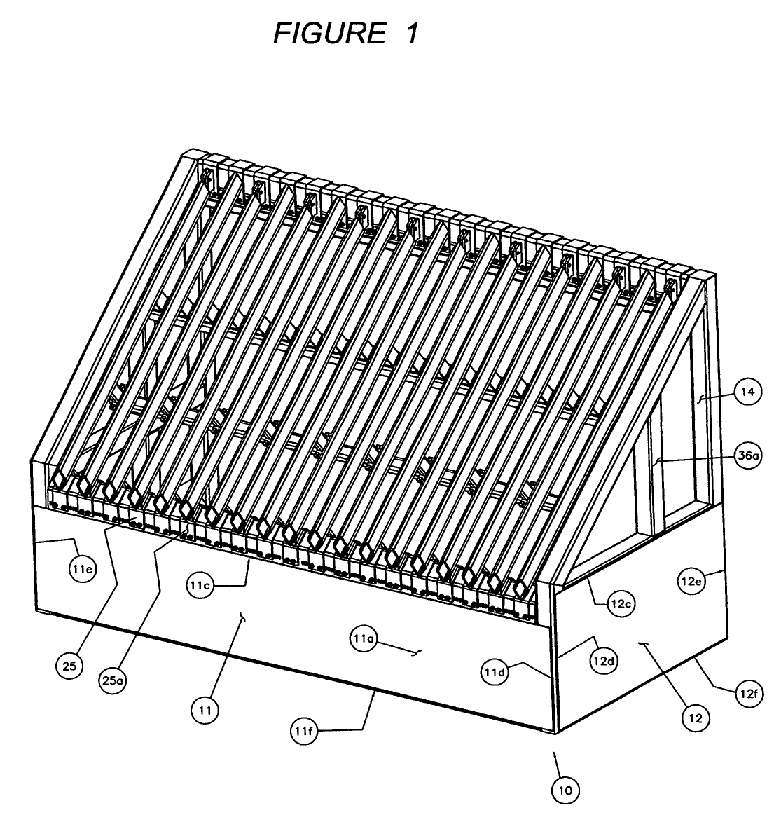

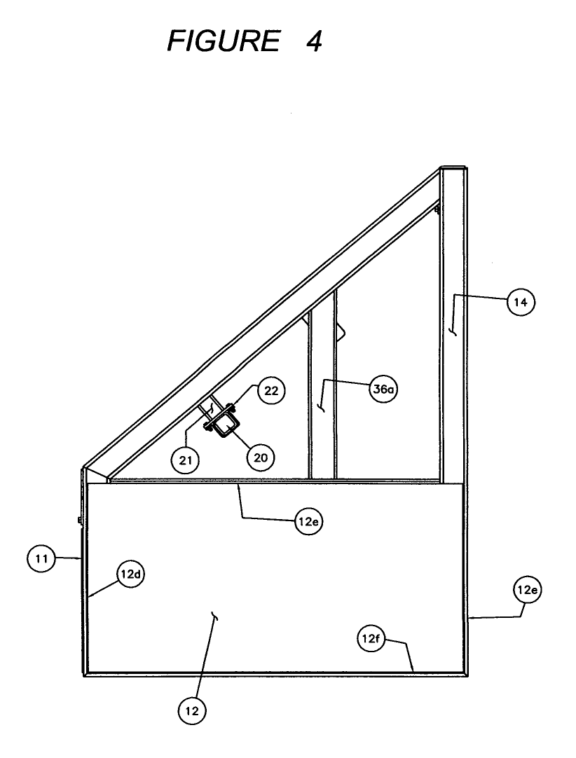

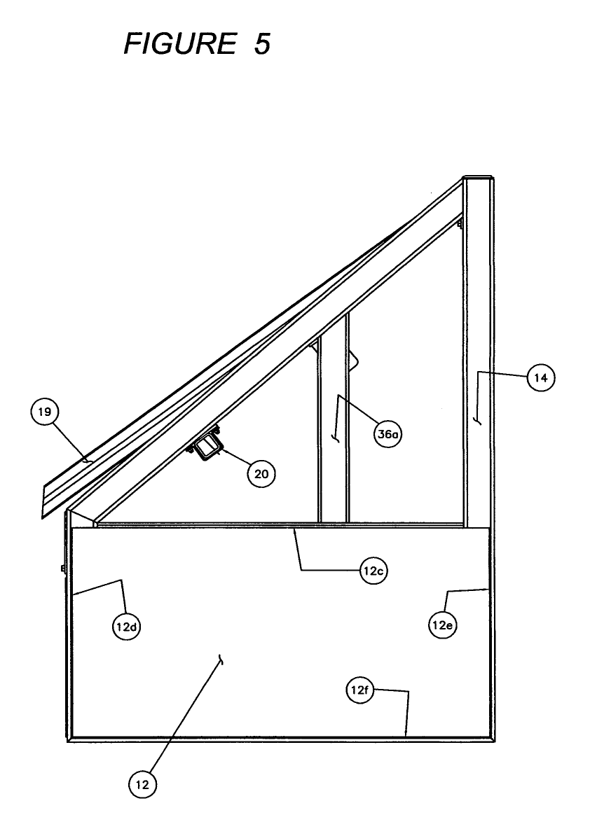

Referring to FIGS. 1 through 6 a description of the operation of the material separator is presented. It should be noted that typically the pieces of the material separator are made from a heavy duty metal and the dimensions and strength of the material can vary depending on the type of material that is too be separated. The basic function of the material separator is described below. Those skilled in the art of welding and manufacturing of metal components or machines will be able to understand the requirement for manufacturing the material separator described below and accomplish the claims set forth in this application. The components of the material separator are generally welded together unless the specific function of the component requires the components to be attached by some other means such as bolting together a component. Other means for attaching or putting parts together include, riveting, extrusion, gluing, bolting or other means known to those skilled in the art.

FIG. 1 shows a perspective view of the material separator 5 with the following major components; a front wall 11, a right wall 12, right back support column 14, upper cross beam 16, lower cross beam 17, fixed bars 18, shift bars 19, upper clips 23, lower clips 25, upper adjustment holes 27, lower adjustment holes 28, right front support member 35a, and a right center support member 36a.

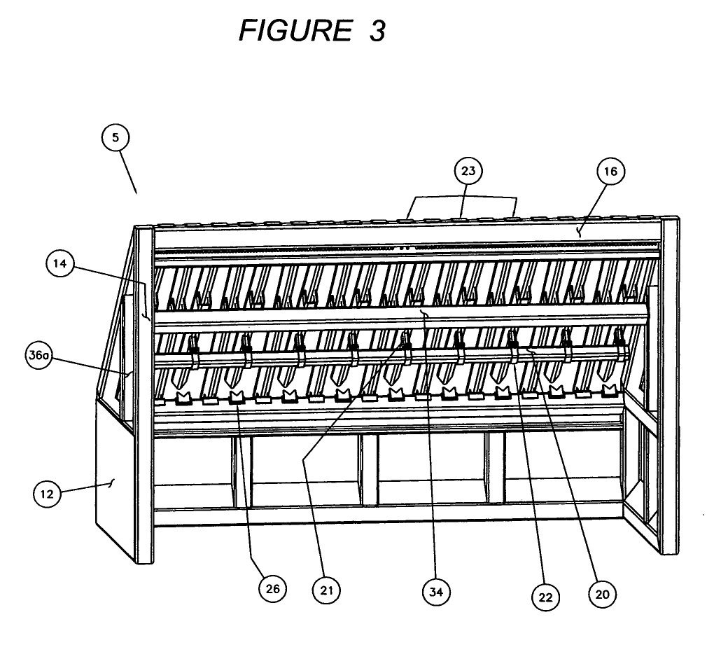

A rectangular frame 10 consists of the front, right and left wall. The front wall is connected to the right wall on the front wall right edge 11d with the right wall connected to the front wall at the right wall front edge 12d. The left wall is connected to the front wall left side edge 11e at the left wall front edge 13d. A back side view, FIG. 3 shows the open back of the rectangular frame. The front, left and right wall are manufactured for excavation type work and are built with sufficient strength to withstand the heavy duty punishment of excavation and material separation. Those skilled in the art have the sufficient knowledge to create or duplicate the rectangular frame consisting of the front, left and right wall.

As can be viewed from FIG. 3, a right back support column 14 extends vertically from the right wall's right back edge. A left back support column 15 extends vertically from the left wall's left back edge. The two back support columns are affixed to the left and right walls by means known to those skilled in the art, including welding, riveting, bolting, or some similar means for attaching heavy duty metal frame to one another.

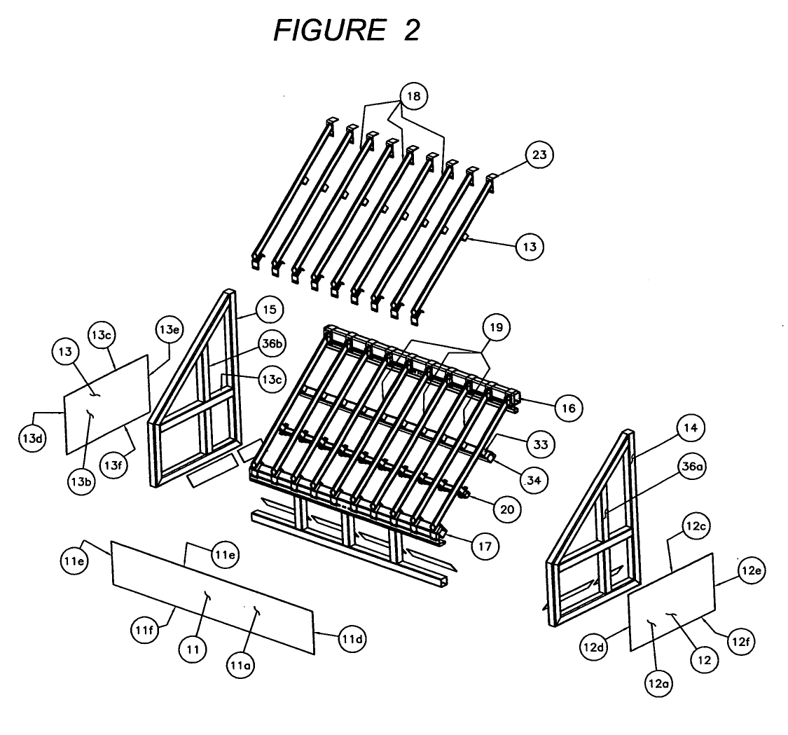

Viewing FIGS. 1, 2 and 3, a number of additional supports are used in the preferred embodiment. Specifically from FIG. 2, a pair of left and right front support members, 35b and 35a, are fixed to the left and right wall top edges, 13c and 12c, and to the top of the left and right support columns 14 and 15. A left and right center support member, 36b and 36a, are attached approximately midpoint of the left and right wall top edge and extend vertically up to a bottom side of the left and right front support members. FIG. 3, a recess support beam 34 is fixed to the top end of the left and right center support members.

At the top of the left and right back support columns is the upper cross beam 16 which sits horizontally from the top of the left and right back support columns. The upper cross beam has a series of upper adjustment holes 27 that are arranged across the upper cross beam 16 and allow for upper clips 23 to be fastened at various points across the upper cross beam 16 by means of an upper clip assembly 23a—consisting or nuts, bolts and washers.

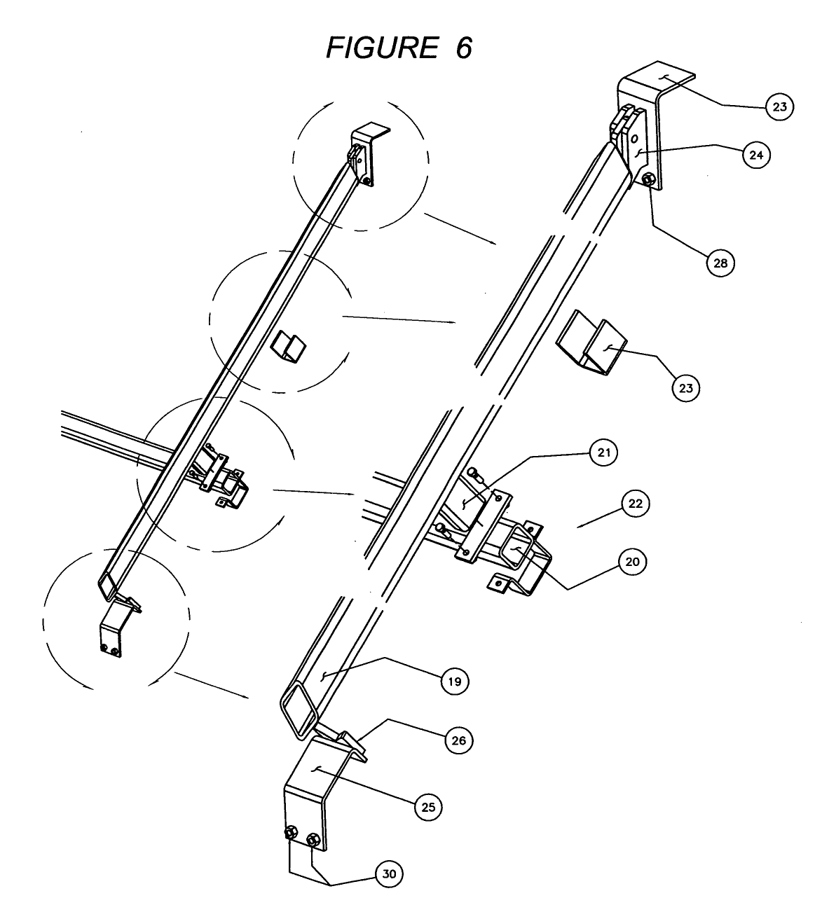

In FIG. 1., a lower cross beam 17 sits atop the front wall top edge 11c and is supported at its left end by the left wall and at its right end it is supported by the right wall. The lower cross beam 17 has lower adjustment holes 29 that are linearly arranged across the lower cross beam. Lower clips 25, FIG. 6 are placed on the lower cross beam in a position or spacing desired by the operator. A lower clip assembly 25a is used to attach and re-attach the lower clip to the lower cross beam. The lower clip assembly 25a, like the upper clip assembly 23a consists of the lower clip, nuts, bolts and washers. Other means for attaching, removing and re-attaching are known to those skilled in the art.

In the preferred embodiment, the operator can manipulate or choose the points at which to attach the upper and lower clips. The operator will place upper and lower clips in tandem and at location along the near parallel upper and lower cross beams that will align the position of one or more fixed 18 and shift 19 bars. The upper clips are attached to the upper cross beam using an upper clip assembly 23a which comprises nuts and bolts inserted through holes located in the upper clip and upper cross beam. The upper clip can be removed and placed in a different location along the upper cross beam depending on where the operator needs to locate the fixed and shift bars. The lower clip is attached to the lower cross beam using a lower clip assembly 25a that is the same as the upper clip assembly 23a.

In the preferred embodiment, the fixed and shift bars are made from a piece of square tube that has a rhombus shaped cross section. A point of the rhombus cross section is placed in the up or top position to facilitate the separating of the excavated material as it is poured across the grate bars. It should be noted that other materials and shapes can be used for the fixed and shift bars and the type of material and shape are dictated by the type of material to be separated.

The fixed bar 18 has an upper end which attaches to the upper clip 23 and a lower end that attaches to the lower clip 25. The fixed bar is typically welded to the upper and lower clips other means for attaching the fixed bar to the upper and lower clips are known those skilled in the art. The upper and lower clips are attached to the upper and lower cross beams by means of the upper and lower clip assemblies 23a and 25a respectively. The clip assembly is generally comprised of bolting the clips at predetermined locations along the upper and lower cross beams. Holes located along the upper and lower cross beams are aligned with holes in the upper and lower clips, the clips are bolted to the cross beams and fixed in place. Since each end of the fixed and shift bar has a clip, the bars are typically set in a parallel manner perpendicular to the lower and upper cross beams

The shift bars 19 have an upper and lower end and are made from the same type of hollow metal bar as the fixed bar. Unlike the fixed bars, at the upper end of the pivot grate bar, a pivot assembly 24 is attached to the upper clip 23. The pivot assembly 24 can be attached to the upper clip by welding, bolting, riveting or by other means known to those skilled in the art. The pivot assembly 24 allows the shift bar to move in an up and down manner with the pivot point being at the attachment of the shift bar 19 to the upper cross beam 16. The lower end of the pivot grate bar rest upon a saddle 26 that is attached to the lower clip.

In the preferred embodiment, a number of fixed and shift bars are positioned across the opening of the rectangular frame. Because the upper cross beam sits higher than the lower cross beam, the fixed and shift bars are slanted with the lower end sitting below the upper end when attached, see FIG. 1. When the material separator is being used, the fixed bars are fixed in place and are not meant to move or pivot like the shift bars 19.

The saddle 26 is welded, bolted or attached to the lower clip 25 by means known to those skilled in the art of metal fabrication. The saddle is a metal piece that has a silhouette or shape to accept the V shape of the bottom side of the rhombus shaped hollow metal bar of the shift bar 19, see FIG. 6. The lower end of the pivot grate bar sits within the V shape of the saddle when excavated material is poured over the material separator. The saddle keeps the shift bar from flexing or moving during the separation process. Because the lower end of the shift bar 19 is not attached or fixed to the lower clip or lower cross beam, the shift bar is free to rotate in an axis perpendicular to the upper cross beam.

In the preferred embodiment, the shift bar, like the fixed bar, has a top and bottom side. The top side has one point of the rhombus facing in the upward or upper position and has another point of the rhombus facing down or toward the bottom. Attached to the bottom side of the one or more shift bars, approximately ⅓ the length of the shift bar from the lower end, is a riser that extends perpendicularly from the length of the shift bar. The riser is a hollow metal bar with an upper and lower end. The upper end of the riser is welded or attached to the bottom side of the shift bar and extending perpendicular from the length of the shift bar. The lower end of the risers 21 are attached to a lift bar 20. The lift bar runs under the one or more shift bars and perpendicular to the direction of the one or more shift bars. Each shift bar has a riser and the risers are attached to the lift bar using a riser clip assembly 22. In the preferred embodiment, a riser u-bracket 22a is bolted to the lift bar by use of nuts 22c, bolts 22b and washers 22d, see FIG. 6.

In the preferred embodiment, the user will set the gap or space between the fixed bar 18 to allow a shift bar 19 to be disposed between each pair of fixed bars 18, see FIG. 1. The space between a fixed and shift bar can be adjusted depending on the type of material that is being excavated or separated or the needs of the operator. Once the material separator is set up, with the fixed bars 18 being fixed to the upper 16 and lower 17 cross beams and the shift bars 19 being disposed between each fixed bar and fixed to the upper cross beam by means of an upper clip 23 with the lower end of the shift bars resting in a saddle 26 that is attached to a lower clip 25 and fixed to the lower cross beam 17, the operator can begin the process of separating material by pouring or dumping material onto the top side of the fixed and shift bars. As material is poured over the top of the bars, looser or smaller material will fall between the space of the fixed and lift bars and come to rest inside the rectangular frame 10. Larger pieces will not be able to fall between the space between the fixed and shift bars and will go down the slanted face of the fixed and shift bars and come to rest in front of the front wall 11. Occasionally, as described in the background section, larger or unusual shaped material pieces will become clogged or jammed between the fixed and shift bars.

As more material becomes clogged or jammed, the efficiency of the material separator becomes less and less. Eventually, the clogged or jammed pieces will prevent or limit the amount of material that can be separated and the operator will need to remove the clogged or jammed material to continue separating.

To remove any material that becomes clogged or jammed between the fixed and shift bars, the operator will rotate the shift bars at the upper clip 23 pivot assembly 24 by applying a force under the lift bar. In the preferred embodiment, the operator will supply the needed force to the lift bar by means of a bucket attached to a piece of earth moving equipment, typically a front loader. This is accomplished by the operator approaching the material separator from the back side of the rectangular frame with the front loader and extending the bucket under the slanted bars of the fixed and shift bars and below the lift beam.

When the bucket is situated below the lift beam, the operator causes the bucket to go up and after contacting the lift beam to raise the lift beam. When the bucket engages and lifts up on the lift beam, the shift bars will pivot at the pivot assembly and the lower ends of the shift bars will come out of the saddle and rotate upward. When the shift bars are lifted, the space between the fixed and shift bars is increased and the clogged or jammed material is able to fall between the larger gap between the fixed and shift bars.

When using the bucket of a front loader to provide the force on the lift bar, the shift bars are able to rotate until the bucket hits the fixed bars. The length of the riser is the distance the shift bars is able to rotate using a bucket. In other embodiments, the shift bars are rotated using hydraulic force supplied to the lift bar. A hydraulic lifting device is positioned under the lift bar and when the operator needs to unclog the material separator, the operator actuates a switch which activates a hydraulic lift that rotates the shift bars in the upward position. The rotation of the shift bars is limited by the length of the hydraulic lift mechanism. Preferably the hydraulic lift is positioned on either or both left and right top edges. The operator can activate the hydraulic lift manually or remotely. Hydraulic lifts are known to those skilled in the art and the placement and use of the lift for rotating the shift bars can be accomplished using several designs and this description is not meant to limit the scope of the claims involving the use of a hydraulic lifting mechanism on the shift bars.

In the preferred embodiment, the space between the fixed and shift bars is determined by the spacing requirements for the material to be separated. The operator will attach the fixed and shift bars to the upper and lower cross beams by attaching, preferably by bolting, the clips to pre-set holes in the upper and lower cross beams. In the preferred embodiment, a shift bar is set between each fixed bar. Once the fixed and shift bars are attached to the upper and lower cross beams—note the shift bar's lower end rests upon a saddle attached to the lower clip and is not fixed to the lower clip—the lift bar is attached to the riser by means of bolting the lift bar to the lower end of the riser using a riser assembly. Once the material separator is put together, the operator is able to separate material.

By using an adjustable means for varying the opening between the fixed and shift bars the user of the present invention does not have to purchase, store, or replace a number or fixed grate sizes or screens for the various material to be separated. Additionally, damaged fixed or shift bars are easily replaced without requiring a new grate or screen to replace the complete grate or screen surface. This innovation saves the user time and money in replacement costs, material costs, and storage fees.

Another feature used in the preferred embodiment is the use of a recess support beam 34 to provide additional support for the fixed and shift bars to the rectangular frame of the material separator. Each fixed and shift bar have a U-bracket 33 welded approximately two thirds of the way up from their lower end. The U-bracket is attached to the bottom side of the fixed and shift bars. The recess support beam 34 has a right end and a left end and the two ends are attached to a left and right central support member 36a and 36b. The left and right central support members extend vertically from the left and right top edges 13c and 12c of the left and right walls 13 and 12. The recess support beam is fixed at a place along the left and right center support members such that the lower end of the U-brackets rest upon the recess support beams when the shift bars lower end is resting in the saddle and the fixed bars are attached to the lower and upper cross beams. This additional support provides a stiffer separating surface for the material to be separated. Without the recess support beam, the fixed and shift bars when under the pressure or weight of the material to be separated bows or flexes causing potential damage to the material separator. When upward force is applied to the lift beam, the U-brackets on the shift bars are lifted off the recess support beam.

I claim:

1. A material separating apparatus comprising:
a frame having a front wall, left wall, and a right wall,
wherein said front wall has two sides and four edges, said sides being an inside side and an outside side, the edges being a top, left, right and bottom,
wherein said left and right walls each have two sides and four edges, said sides being an inside side and an outside side, the edges being a top, a front, a back, and bottom edge,
wherein said left wall front edge is attached to said front wall left edge and said right wall front edge is attached to said front wall right edge, said frame having an approximately rectangular shape with the front, left and right walls forming three sides of said shape,
wherein said inside walls of said front, left and right wall face inside the rectangular shape,
a right back support column having an upper and lower end said upper end rising vertically from the back top edge of the right wall,
a left back support column having an upper and lower end said upper end rising vertically from the back top edge of the left wall,
an upper cross beam with a right end and a left end, said left end of the upper cross beam attached to the upper end of said left back support column, said right end of the upper cross beam attached to the upper end of said right back support column, wherein said upper cross beam is approximately horizontal to said frame,
a lower cross beam with a right end and a left end, said left end of the lower cross beam supported and attached to the top front edge of said left wall, said right end of the lower cross beam supported and attached to the top front edge of said right wall,
said upper and lower cross beams being approximately parallel to each other with the upper cross beam being higher with respect to the lower cross beam and toward the back end of said frame,
two or more fixed bars, said fixed bars having an upper and lower end,
wherein said upper end of the two or more fixed bar is firmly attached to said upper cross beam and said lower end of the two or more fixed bars is firmly attached to said lower cross beam,
wherein said two or more fixed bars are attached to said upper and lower cross beams in an approximately parallel arrangement,
one or more shift bars, said shift bars having a top and bottom side and an upper and lower end,
wherein said upper end of said shift bars is pivotally fixed to said upper cross beam and said lower end rests upon said lower cross beam,
wherein a first shift bar is attached to said upper cross beam with each additional lift bar after said first shift bar being arranged approximately parallel to said first shift bar,
a riser attached to the bottom side of the one or more shift bars and said riser having an upper and lower end with said upper end attached to said one or more shift bars,
a lift bar attached to the lower end of said one or more risers,
means for providing an upward force to said lift bar.

2. The material separator of claim 1 further comprising means for adjusting the space between said two or more fixed bars.

3. The material separator of claim 1 further comprising means for adjusting the space between two or more lift bars.

4. The material separator of claim 1 wherein said means for pivoting the one or more lift bars include applying an upward force to the lift bar.

5. The material separator of claim 4 wherein said force is supplied by means of a front loader with a bucket wherein said front loader positions the bucket under the lift bar and then raises said bucket and thereby lifting said lift bar.

6. The material separator of claim 4 wherein said upward force is supplied by means of hydraulic forces.

7. The material separator of claim 2 wherein said means for adjusting said space between said two or more fixed bars comprises attaching an upper and lower clip to an upper and lower end of said fixed bars and aligning one or more holes located in said clips with one or more holes in said upper and lower cross beams, inserting a bolt through said holes of said clips and beams and then securing each bolt with a nut.

8. The material separator of claim 3 wherein said means for adjusting said space between said two or more shift bars comprises pivotally attaching an upper clip to an upper end of said shift bars and aligning one or more holes located in said clips with one or more holes in said upper cross beam, inserting a bolt through said holes of said clips and beams and then securing said bolt with a nut.

9. The material separator of claim 8 further comprising a lower clip attached to said lower cross beam, a saddle fixed to said lower clip, one or more holes in said lower clips, one or more holes in said lower cross beam, wherein said holes in said lower clip are aligned with holes in said lower cross beam, a bolt placed through the one or more holes and then securing each bolt with a nut.
